(19) United States
(12) Patent Application Publication
(10) Pub. No.: US 2005/0229200 A1
(43) Pub. Date: Oct. 13, 2005

(54) Method and system for adjusting a display based on user distance from display device

(75) Inventors: Dustin Kirkland, Austin, TX (US); David Bruce Kumhyr, Austin, TX (US); Emily Jane Ratliff, Austin, TX (US); Michael Austin Halcrow, Austin, TX (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/821,049

(22) Filed: Apr. 8, 2004

(51) Int. Cl. H04N 7/16; H04N 5/232

(52) U.S. Cl. 725/12; 348/352

(57) ABSTRACT

The present invention is a method and system that adjusts the contents on a display screen based on the distance of the user from the screen. This invention comprises a display screen with a distance approximator mechanism either attached the display screen or positioned in close proximity to the screen. This distance approximator detects user movement and calculates the distance that the user is from the screen. As the distance of the user from the screen increases or decreases, the method of the invention adjusts the contents of the screen. The screen adjustments can comprise enlarging the size of the information on the screen as the user moves further from the screen. The contents can also be reduced as the user returns to a local distance to the display screen. The display content adjustment techniques of the present invention enable a user to view screen contents from abnormally far distances from the screen without the need for the user to continually travel back and forth to and from the display screen.

### FIELD OF THE INVENTION

The present invention is a method and system for displaying information on a display device and in particular to a method and system that adjusts the size of the display and/or specific contents in the display based on the distance of the user from the display device.

### BACKGROUND OF THE INVENTION

Along with the recent popularization of creating and manipulating images on a personal computer, there is a growing demand for retrieving image information from a television set, a videocassette recorder or other devices such as a CD player or an audio cassette player for use in a variety of applications. Often, it is necessary to connect these imaging devices and music devices to the personal computer display means, which is usually a CRT monitor. The popular and growing connection means is a wireless connection. These wireless connections usually incorporate some form of lazar or radar beam that establishes a communication path between the peripheral device and the computing device. The use of wireless peripheral devices provides enhanced flexibility in that the user can freely move about without concern about wires and cables that traditionally provide the connection means between the computer and the peripheral devices.

In addition to the use of wireless peripheral devices, many people work in computer network environments in which the user works from multiple computers located in general proximity to each other. Because of these computing networks and the use of wireless peripheral devices, many users of computing devices view video output display devices from various distances. Based on the particular distance of the user from the display device, text images, graphics images and video displays on the display device may or may not be easily visible. Additionally, some users have vision impairment conditions in that, some users are far-sighted, others are near-sighted, and some are nearly blind. Other users regularly change their distance to a display device, such as when giving a presentation, or in point-of-sale systems. Due to these conditions, it may be desirable to vary the size of the data displayed on the screen in order to improve the visual accessibility.

In the past, there have been efforts to enhance the ability to view computer display devices especially for those with vision impairments. Prior art in this field includes some accessibility software bundled with Linux and Microsoft operating systems, and even applications such as web browsers. Examples of operating systems that provide graphical user interfaces and WYSISYG technologies are WINDOWS 95 and WINDOWS 98, which are manufactured by the Microsoft Corporation of Redmond, Wash.

In U.S. Pat. No. 6,618,045, issued to Microsoft Corporation, methods and arrangements are provided that automatically adjust various operating settings associated with a display device in response to detected lighting conditions in the environment of the device. The methods and arrangements respond to dynamically changing light conditions in an effort to significantly maintain the output quality of the display as previously established by the user. Memory is provided and configured to store at least one user preference value. At least one display parameter controller unit operatively associated with the display device is also provided and configured to respond to a parameter setting. At least one sensor unit, which is responsive to light, is configured to output a detected light value to logic. The logic is operatively coupled to the memory, the display parameter controller unit and the sensor unit. The logic is configured to output the parameter setting to the parameter controller unit based on the user preference value and the detected light value. Thus, for example, the user can establish a preferred setting for the brightness, contrast, color, etc., for a given lighting condition. The logic can be further configured to output the parameter setting based on the preference value, detected light value, and specified curve-fitting data.

In another U.S. Pat. No. 6,579,324, a method for using an indicator, known as “See Through View,” that allows a user to select a region on the display device and still see the visual attributes of the contents as they will appear when the region is deselected. When the user selects a region on the display device, the invention “shades” the background of the selected region. The contents within the selected region are left unchanged. Shading is accomplished by combining each original background base color with a selection shading color to produce a corresponding blended color, or colors. If the corresponding blended color is similar to the background base color, the blended color is either lightened or darkened, as needed to produce an adjusted blended color. Each blended color, or the adjusted blended color (as required) replaces the corresponding base background color within the selected region. The effect is that the selected region and background items appear “shaded.” This allows the user to see the visual attributes of the contents of the selected region, as they would actually appear.

Using color to enhance to visibility of a display is a known technique. Referring to FIG. 1, shown is a color enhanced display scheme used to enhance a display for a viewer. This feature is an example of a solution by Microsoft Corporation for some users that have poor eyesight and as a result have great difficulty viewing a monitor. The operating system for a computer can have various color background schemes. For example, one user could have a blue on white color scheme, while someone else may have a read on pink color scheme. The particular color scheme can change the way text is displayed on the screen. One scheme shown in FIG. 1 is the ‘High Contrast White [extra large]’ scheme. This particular scheme changes the way all windows behave. This particular scheme makes all of the words very large as shown. The larger text makes it easier for the seeing impaired to read. This concept is similar to large print books.

Although these techniques attempt to address the problem of modifying the display screen in response to conditions surrounding a display, these solutions address display enhancements primarily by changing or adjusting the color on the display. These solutions do not address problems of users moving various distances from the display screen. There remains a need for a method and system that can detect user movement and adjust the display screen based on the distance of the user from the display device.

### SUMMARY OF THE INVENTION

It is an objective of the present invention to provide a method and system that adjust the contents of a display screen based on the distance of the user from the display screen.

It is a second objective of the present invention to provide a method and system that incorporate a distance approximation mechanism to detect the movement of a user and determine the change in distance of the user from the display screen.

It is a third objective of the present invention to provide a method and system that automatically adjust the size of the display screen contents based on the approximate distance of the user from the display screen.

It is a fourth objective of the present invention to provide a method and system that incorporate a signal mechanism positioned on the user to assist in detecting user movement from one location to another location.

It is a fifth objective of the present invention to provide a method and system that adjust only selected portions of a screen display based on the distance of the user from the screen.

The present invention combines screen display and object approximation technologies in a unique manner that add considerable value to a computing environment. Particularly when a user is moving around while using a computer (giving a presentation, utilizing a whiteboard, engaging in a conference), that user would benefit from a computing device with an automatically adjusting display size. Additionally, this invention benefits the disabled, as well as even people with minor vision debilities.

The novel part of this invention is the combination of software that adjusts the size of text, images, or video on a screen based on the computer's determined distance from the user and a defined profile for that user.

In summary, the present invention incorporates a distance approximation device attached to or positioned near the display screen (CRT monitor, flat panel LCD, etc). This device uses known technologies, such as radar or sonar, to determine its distance from the user. To improve such estimates, the user might actually wear a special lapel pin, or other such device that can emit a signal, either at specified intervals or when activated by a requesting signal. Thus, as the computer detects that the user has moved farther from the display screen, the computer will adjust the display properties according to the user's configured preferences. The first component of the invention is that of the Distance Approximator. Off-the-shelf ultrasonic devices can gauge distances between walls, accurate to fractions on an inch. Similar radar and laser technology exists, such as that which governs automatic doors in grocery stores.

As mentioned, the performance of these distance-approximating devices could be improved by placing some sentinel on the user, perhaps a special lapel pin, or even incorporating into an existing device, such as a badge. This device could uniquely identify the user and prevent interference and miscalculations.

The user might also customize the default profile and choose what actions the computer should take in adjusting the display when their distance has changed locations. For example, one user may only want the computer to adjust the display if their changed distance remains nearly constant for 5 or more seconds, while another user may want the display to change more or less rapidly. One user might prefer that only the currently active window or section of the screen be adjusted, perhaps maximized to full screen if it is not already. This active window of the display might be auto-scrolled so that all of the data will eventually be displayed at this larger font. Instead of the current window, the center of the screen might be blown up. Some users may wish the resolution to be adjusted, while others would prefer that the font size or image size be scaled. In any case, a suitable configuration tool is provided that allows a user to customize and optimize the settings that will garner the best visual accessibility regardless of the location of the user with respect to the display screen.

### DESCRIPTION OF THE DRAWINGS

FIG. 1 is an example of illustration of a high contrast extra large scheme used for view display enhancement.

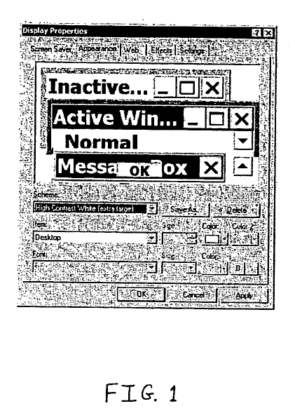

FIG. 2 depicts a conventional pictorial representation of data processing system.

FIG. 3 depicts a pictorial representation of data processing system with user distance approximation capabilities that can be used in the implementation of the present invention.

FIG. 4a is a display screen containing text and graphic data content.

FIG. 4b is a display of FIG. 4a showing various sections of the display.

FIG. 5 is the display screen containing enhanced contents of FIG. 4 in accordance with the method and system of the present invention.

FIG. 6 is a flow diagram of the primary steps of the present invention.

FIG. 7 is a detailed flow diagram of the steps of the present invention.

### DETAILED DESCRIPTION OF THE INVENTION

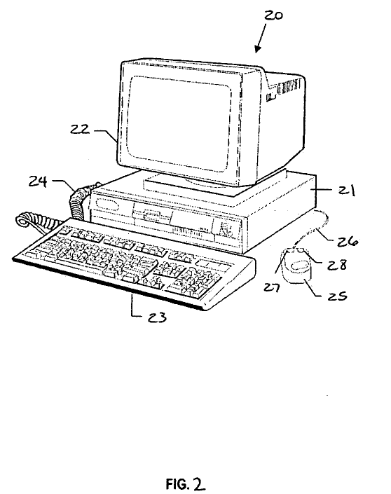

The present invention provides a method and system that has the capability to adjust the contents of a display based on the distance of the user from the display screen. This ability to adjust the screen contents will provide enhanced viewing capability for the user. With reference now to FIG. 2, there is depicted a pictorial representation of conventional computing device 20. As may be seen, data processing system 20 includes processor 21 that preferably includes a graphics processor, memory device and central processor (not shown). Coupled to processor 21 is video display 22 which may be implemented utilizing either a color or monochromatic monitor, in a manner well known in the art. Also coupled to processor 21 is keyboard 23. Keyboard 23 preferably comprises a standard computer keyboard, which is coupled to the processor by means of cable 24. Also coupled to processor 21 is a graphical pointing device, such as mouse 25 (other examples of pointing devices include a light pen and a roller ball). Mouse 25 is coupled to processor 21, in a manner well known in the art, via cable 26 As is shown, mouse 25 may include left button 27, and right button 28 each of which may be depressed, or “clicked”, to provide command and control signals to data processing system 20. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 20 may be implemented utilizing a personal computer.

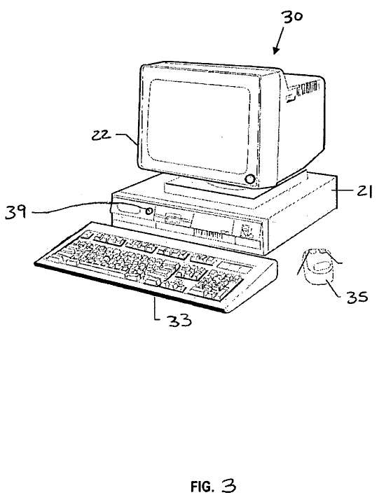

Referring to FIG. 3, shown is a pictorial representation of a computing device modified in accordance with the present invention. This device 30 has a wireless keyboard 33 and a wireless mouse 35. In accordance with the present invention, the computing device can contain a distance approximation sensor 39 that can detect the movement of a user and determine the distance between the user and the computing device. In one implementation, the distance sensor can be an ultrasonic device that emits sound waves toward the user. The sound waves hit the user and reflect back to the sensor. The sensor detects these reflected waves. In some of these devices, the sensor then calculates the time elapsed from the emission of the sound wave until it is reflected off the user and back to the sensor. From this distance, the sensor can determine the distance between the user and the computing device. This described method is but one way to determine distance between the user and the computer. The present invention can implement other distance approximation methods as well.

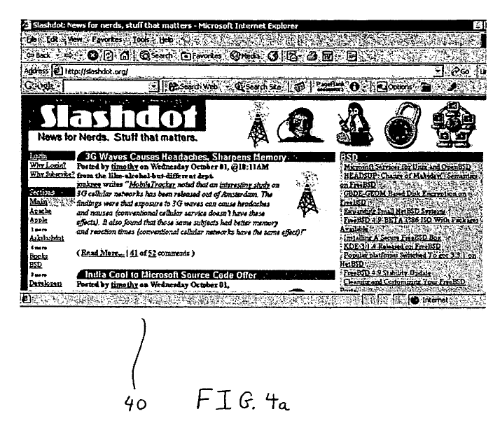

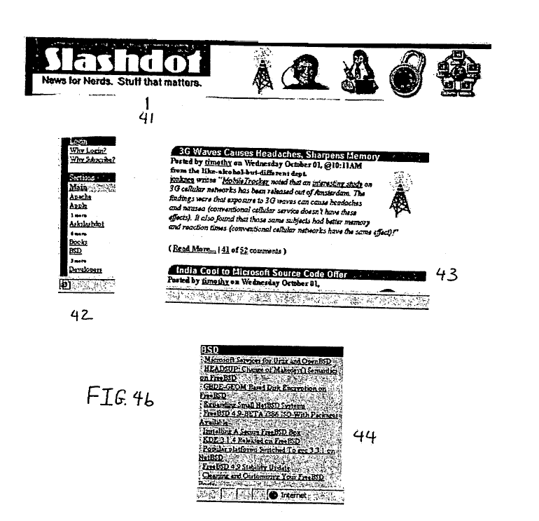

FIGS. 4a and 4b show a typical screen display 40 containing both text and graphics information. FIG. 4a shows the entire display as it would appear on the screen. The screen can be arranged in sections as illustrated in FIG. 4b. Section 41 can be a section that does not readjust based on the location of the user. Sections 42, 43 and 44 can be sections of the display that do re-adjust when the location of the user changes.

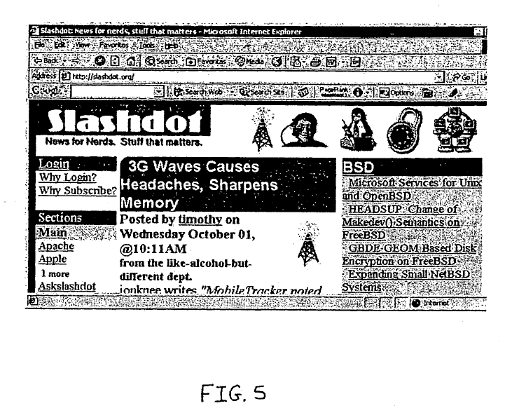

FIG. 5 is the display screen containing enhanced contents of FIG. 4a in accordance with the method and system of the present invention. When viewing the contents of FIG. 4a, as a user moves further from the display screen, the contents of this display in FIG. 4a will become harder to view. In the present invention, as the user moves away from the display screen, the display contents are enlarged to able to user to view these contents at greater distances from the screen. In FIG. 5, the data enlargement occurs by increasing the size of the fonts for the letters. However, because the display screen has an overall fixed length, when there is an enlargement of the font size of the screen contents, some of the information in the smaller display is not seen on the display screen. Referring to the contents of the section 43, as seen the top line ‘3G Waves Causes Headaches, Sharpens Memory’ in FIG. 4a appears as one line on the display screen. Because of the increased size of the letters, the contents of this line will not all fit on one line in FIG. 5. As a result, the text wraps around and appears in multiple lines in the display in FIG. 5. The user would need to scroll down in order to view the entire contents of the display. However, at greater distances from the display screen, the user would be able to easily view the contents of section 43 on the screen. If the user were primarily interested in the contents of section 43, the user would be able to see this data from greater distances for the display screen.

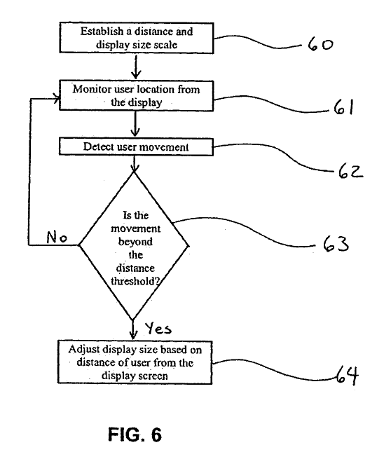

FIG. 6 is a flow diagram of the primary steps of the present invention. As shown, the initial step 60 is to establish a distance and size scale. This scale can be a linear relationship such that for every distance increment, the display size increases or decreases a certain percent. Step 61 monitors the user location with respect to the display screen. This monitoring step is done in conjunction with the previously discussed distance sensor 39. Sound waves emitted by the distance sensor will enable the sensor to determine the location of the user. In this implementation, there can be a local distance range in the immediate proximity of the display screen. Although the user may be moving, as long as the user remains in this range, there is no desire to adjust the screen size. As a result, the method remains in a strictly monitoring mode. If the user moves outside the established local range of the display, step 62 will detect the user movement. Step 63 will determine if the user movement is beyond an adjustment threshold distance. The user can also establish this threshold distance as part of the distance and size scale of step 60. If the determination is that the user has moved a distance beyond the user threshold, step 64 performs a screen adjustment in accordance with the distance and size scale established in step 60. At the completion of the adjustment step, the method returns to step 61 to continue the distance monitoring process.

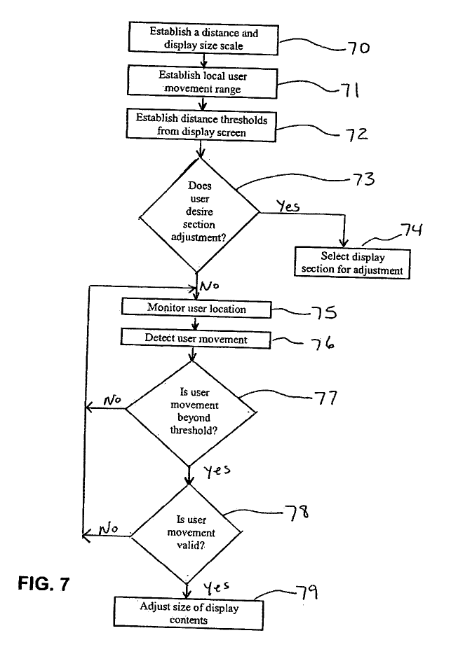

FIG. 7 shows a detailed flow diagram of the steps in an embodiment of the present invention. As with FIG. 6, step 70 establishes a distance and display size ratio. Step 71 establishes the local area of the user. As mentioned, the user can move around in this area without detection or activation of display adjustment steps. Step 72 establishes movement and distance threshold levels for movement of the user from the screen. There can be one or more movement threshold levels. For example, the normal distance of a user from a display is 24 to 36 inches. When the user is within 42 inches from the screen, the user would be in the local area of the display device. In this area, there would be no display screen adjustments based on the user movement. An initial user movement threshold distance could be 48 inches. When the distance approximator detects the user movement beyond that distance, there would an initialization of the display screen adjustment steps herein. If the detected distance were beyond, for example 54 inches, the size of the display would increase in proportion to the distance.

Step 73 gives the user the option to adjust the entire screen or specific sections of the screen as illustrated in FIG. 4b. This feature may be useful if the user is only interested in viewing certain screen contents from a far distance. If the user does want to specify a particular portion of the screen, the method moves to step 74 where the user can identify the particular section of the display for adjustment. If the user does not desire to select a specific section of the document for adjustment, the method moves to the monitoring step 75. In this step, the distance of the user is monitored using the distance approximator. As the approximator calculates the user distance from the display screen, this distance is compared to the threshold distances. In this method, not every little movement of the user is detected. The time interval in which the distance approximator calculates the user distance can also established by the user or can be standard time interval or can be based on certain user movements. When the monitor step detects a user movement in step 76, step 77 of the method determines whether the user movement is beyond an established distance threshold. If the movement is not beyond an established threshold, the method returns to the monitoring step 75.

If the movement is beyond a threshold distance, step 78 determines whether the movement is valid. In this valid movement step, there is an attempt to adjust the display screen when the user had made a change in location. It is not the desire of the invention to constantly adjust the screen. If the user changes location in order to retrieve some materials and then returns to the local area, the screen should not make an adjustment to the display screen. The implementation of this step could involve a calculation of the time the user is in the new location before adjusting the display screen. When the user remains a certain distance from the display for more than a set time period, the movement is considered valid. If the determination is that the movement is not valid, the method returns to the monitoring step 75. If the determination is that the movement is valid, the method moves to the display screen adjustment step 79.

These techniques of the present have other application in addition to its use with computing devices such as computer terminals. In the retail sales arena and the fast-food industries, the invention would be particularly useful in some current point-of dale devices. Cashier attendants at fast-food location, for example, take an order on a touch screen, and then move about the kitchen preparing drinks, gathering sandwiches, and side orders. Each time they move away from the screen, it becomes harder for them to read the order that they are preparing. In such cases, software designed specifically for this invention could contain “hot-spots” that re enlarged when the user moves farther from the display. This invention solves this problem. The display screen in this application may list five orders. As the user moves from the screen, the display may expand and show the user only the top two or three orders. The top orders having more priority to fill. As the user comes closer to the screen, the display would reduce in size and therefore show more orders.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

1. A method for adjusting a screen display based on a user's distance from the display device comprising the steps of:
establishing a relationship between the distance of a user from a display screen and the size of the display on the screen;
detecting the movement of the user with respect to the display screen;
adjusting the size of the screen display based on the location of the user with respect to the display screen; and
displaying the display in the adjusted display size.

2. The method as described in claim 1 further comprising the step of establishing a threshold distance of the user from the display screen.

3. The method as described in claim 2 further comprising before said size adjusting step, the step of determining whether detected movement of the user is beyond the established threshold distance.

4. The method as described in claim 2 further comprising the step of establishing a local user area within a defined distance from the display screen.

5. The method as described in claim 4 further comprising the steps of:
determining whether display has multiple sections; and
when display does have multiple sections, identifying a selected section by user for adjustment.

6. The method as described in claim 4 wherein the threshold distance is the outer boundary of the local user area.

7. The method as described in claim 2 wherein the threshold distance comprises multiple threshold ranges.

8. The method as described in claim 2 further comprising before said adjusting step, the step of determining whether said detected user movement is a valid movement.

9. The method as described in claim 8 wherein said valid movement determination step further comprises determining the amount of time a user is out of the local area.

10. The method as described in claim 9 further comprises the step of establishing a minimum time the user has to be out of the local area to trigger a movement beyond the threshold distance.

11. A computer program product in a computer readable medium for adjusting a screen display based on a user's distance from the display device comprising:
instructions for establishing a relationship between the distance of a user from a display screen and the size of the display on the screen;
instructions for detecting the movement of the user with respect to the display screen;
instructions for adjusting the size of the screen display based on the location of the user with respect to the display screen; and
instructions for displaying the display in the adjusted display size.

12. The computer program product as described in claim 11 further comprising instructions for establishing a threshold distance of the user from the display screen.

13. The computer program product as described in claim 12 further comprising before said size adjusting instructions, instructions for determining whether detected movement of the user is beyond the established threshold distance.

14. The computer program product as described in claim 12 further comprising instructions for establishing a local user area within a defined distance from the display screen.

15. The computer program product as described in claim 14 further comprising:
instructions for determining whether display has multiple sections; and
when display does have multiple sections, instructions for identifying a selected section by user for adjustment.

16. The computer program product as described in claim 12 further comprising before said adjusting instructions, instructions for determining whether said detected user movement is a valid movement.

17. The computer program product as described in claim 16 wherein said valid movement determination instructions further comprise instructions for determining the amount of time a user is out of the local area.

18. The method as described in claim 17 further comprises instructions for establishing a minimum time the user has to be out of the local area to trigger a movement beyond the threshold distance.

19. A system for adjusting a screen display based on a user's distance from the display device comprising
a display device;
a distance approximation device for determining the location of a user from said display device;
software for determining the whether the determined distance of a user from the display device is beyond an established threshold distance; and
software for adjusting the size of the display on the display device based on the determined distance of the user from the display device.

20. The system as described in claim 19 wherein said distance approximation device is part of the display device.

21. The system as described in claim 19 wherein said distance approximation device is positioned immediately adjacent the display device.

22. The system as described in claim 19 wherein said size adjusting software further comprises routines to adjust one or more sections of the display.
